(19) United States
(12) Patent Application Publication
(10) Pub. No.: US 2018/0146365 A1
(43) Pub. Date: May 24, 2018

(54) DEVICE CAPABILITY EXCHANGE IN MULTI-SIM AND CONCURRENT-RAT DEVICES

(71) Applicant: QUALCOMM Incorporated, San Diego, CA (US)

(72) Inventors: Muthukumaran Dhanapal, San Diego, CA (US); James Hutchison, IV, San Diego, CA (US); Parthasarathy Krishnamoorthy, San Diego, CA (US); Shravan Kumar Raghunathan, San Diego, CA (US)

(21) Appl. No.: 15/360,381

(22) Filed: Nov. 23, 2016

(51) Int. Cl. H04W 8/24; H04W 8/18; H04W 72/04; H04W 76/04

(52) U.S. Cl. CPC H04W 8/24; H04W 8/18; H04W 88/06; H04W 76/045; H04W 72/0413

(57) ABSTRACT

Examples described herein relate to apparatuses and methods for a wireless communication device having a first Subscriber Identity Module (SIM) enabling a first subscription and a second SIM enabling a second subscription to manage communications over the first subscription and the second subscription including determining a change in device mode associated with the first subscription and updating the change in device mode by sending a device capability information message to the first network associated with the first subscription in response to determining the change in device mode without performing a de-attach procedure with the first network.

### BACKGROUND

A wireless communication device, such as a mobile phone device or a smart phone, may include two or more Subscriber Identity Modules (SIMs). Each SIM may enable at least one subscription via one or more Radio Access Technologies (RATs). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. A Concurrent RAT (CRAT) wireless communication device refers to a multi-SIM wireless communication device that has two or more RATs concurrently enabled. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (1×), General Packet Radio Service (GPRS), Wi-Fi, Personal Communications Service (PCS), and other protocols that may be used in a wireless communications network or a data communications network.

Carrier aggregation refers to aggregating two or more channels to improve data throughput. A multi-SIM or CRAT wireless communication device with carrier aggregation enabled can experience tremendous power consumption due to communications with multiple cells. Some devices can reduce power consumption through mechanisms in the application layer that disable or downgrade carrier aggregation, switch from a multi-SIM or CRAT mode to a single-SIM mode, or the like. Such changes in device modes may be frequent and dynamic, especially in a mobility scenario. Typically, the wireless communication device advertises the changes in device capabilities through a de-attach and re-attach procedure with an associated network. Frequent de-attach and re-attach procedures with the network can result in frequent interruptions in service, thus leading to negative user-experience.

### SUMMARY

Examples described herein relate to a multi-Subscriber Identity Module (SIM) or Concurrent Radio Access Technology (CRAT) wireless communication device exchanging device capabilities with an associated network. Instead of performing de-attach and re-attach procedures every time the device capabilities or device modes change, the wireless communication device may send a device capability information message to the associated network to inform the network of the change in device capabilities or device modes. In some examples, the device capability information message may be an Extended Long Term Evolution (LTE) Signaling (ELS) message sent to the network over an uplink Dedicated Control Channel (DCCH) channel. In some examples, the network may inform the wireless communication device of the network's ability to handle the device capability information message (in lieu of performing the de-attach and re-attach procedures) by broadcasting System Information Blocks (SIBs) indicating the network's ability. In one example, the device capability information message may be autonomously indicated.

Therefore, seamless mobility can be achieved even as the wireless communication device frequently changes its device capabilities or mode. In some examples, examples presented herein can be practiced in a software-only update to the existing framework, thus eliminating a need for hardware update. In addition, given that wireless communication device exchanges messages with the network to update the change in device mode instead of performing the de-attach and re-attach procedures, signaling procedures associated with such updates can be reduced. This can, in turn, cause an improvement in power consumption.

In various examples, a method for a wireless communication device having a first Subscriber Identity Module (SIM) enabling a first subscription and a second SIM enabling a second subscription to manage communications over the first subscription and the second subscription includes determining a change in device mode associated with the first subscription, and updating the change in device mode by sending a device capability information message to the first network associated with the first subscription in response to determining the change in device mode without performing a de-attach procedure with the first network.

In some examples, the change in device mode includes a change from a multi-SIM mode to a single-SIM mode, or a change from a Concurrent-SIM (CRAT) mode to a single SIM mode.

In some examples, the change in device mode includes a change in band preference associated with the first subscription.

In some examples, the change in device mode includes upgrading or downgrading carrier aggregation.

In some examples, upgrading the carrier aggregation includes adding an additional component carrier.

In some examples, downgrading the carrier aggregation includes removing a current component carrier.

In some examples, the change in device mode is updated without performing a re-attach procedure with the first network.

In some examples, the change in device mode is determined while the first subscription is attached to the first network.

In some examples, the device capability information message is an Extended Long Term Evolution (LTE) Signaling (ELS) message.

In some examples, the device capability information message is sent via an uplink Dedicated Control Channel (DCCH) channel.

In some examples, the device capability information message is an Over-The-Air (OTA) message.

In some examples, the method further includes receiving a network capability information message from the first network indicating that the first network is capable of processing the device capability information message.

In some examples, the network capability information message is received via a System Information Block (SIB).

In various examples, a wireless communication device includes at least one radio frequency (RF) resource, a processor configured to connect to a first SIM associated with a first subscription and to a second SIM associated with a second subscription, and configured with processor-executable instructions to determine a change in device mode associated with the first subscription, and update the change in device mode by sending a device capability information message to the first network associated with the first subscription in response to determining the change in device mode without performing a de-attach procedure with the first network, and a memory.

In some example, a method for a processor of a first network to manage communications with a wireless communication device having at least a first SIM that enables a first subscription associated with the first network includes receiving a device capability information message from the wireless communication device indicating a change in device mode, and based on the device capability information message, updating the device mode with respect to the first subscription of the wireless communication device without performing a de-attach procedure with the wireless communication device.

In some examples, the change in device mode includes a change from a multi-SIM mode to a single-SIM mode, or a change from a CRAT mode to a single SIM mode.

In some examples, the change in device mode includes a change in band preference associated with the first subscription.

In some examples, the change in device mode includes upgrading or downgrading carrier aggregation.

In some examples, upgrading the carrier aggregation includes adding an additional component carrier.

In some examples, downgrading the carrier aggregation includes removing a current component carrier.

In some examples, the change in device mode is updated without performing a re-attach procedure with the wireless communication device.

In some examples, the device capability information message is received while the first subscription is attached to the first network.

In some examples, the device capability information message is an ELS message.

In some examples, the device capability information message is received via an uplink DCCH channel.

In some examples, the device capability information message is an OTA message.

In some examples, the method further includes sending a network capability information message to the wireless communication device indicating that the first network is capable of receiving and processing the device capability information message.

In some examples, the network capability information message is sent via a SIB.

In various examples, a base station associated with a first network having a processor capable of managing communications with a wireless communication device having at least a first SIM that enables a first subscription associated with the first network, the processor is capable of configuring the base station to receive a device capability information message from the wireless communication device indicating a change in device mode, and based on the device capability information message, updating the device mode with respect to the first subscription of the wireless communication device without performing a de-attach procedure with the wireless communication device.

### BRIEF DESCRIPTION OF THE DRAWINGS

The accompanying drawings, which are incorporated herein and constitute part of this specification, illustrate exemplary examples of the disclosure, and together with the general description given above and the detailed description given below, serve to explain the features of the various examples.

FIG. 1 is a schematic diagram of a communication system in accordance with various examples.

FIG. 2 is a component block diagram of a wireless communication device according to various examples.

FIG. 3 and FIG. 3A are process flowchart diagrams illustrating capability exchange methods according to various examples.

FIG. 4A is a process flowchart diagram illustrating a capability exchange method according to various examples.

FIG. 4B is a process flowchart diagram illustrating a capability exchange method according to various examples.

FIG. 5 is a diagram illustrating an example of a System Information Block (SIB) used to transmit the network capability information message.

FIG. 6 is a signaling diagram illustrating a capability exchange method according to various examples.

FIG. 7 is a process flowchart diagram illustrating a capability exchange method according to various examples.

FIG. 8 is a process flowchart diagram illustrating a capability exchange method according to various examples.

FIG. 9 is a component block diagram of a wireless communication device suitable for use with various examples.

### DETAILED DESCRIPTION

Various examples will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

A modern communication device, referred to herein as a wireless communication device, User Equipment (UE), or Mobile Station (MS), may be a cellular telephone, smart phone, personal or mobile multi-media player, personal data assistant, laptop computer, personal computer, tablet computer, smart book, palm-top computer, wireless electronic mail receiver, multimedia Internet-enabled cellular telephone, wireless gaming controller, and similar personal electronic device. Such a wireless communication device may include at least one Subscriber Identity Module (SIM), a programmable processor, memory, and circuitry for connecting to two or more mobile communication networks.

A multi-SIM wireless communication device may include one or more SIMs that enable access to one or multiple separate mobile communication networks. The access to mobile communication networks may be facilitated by Radio Access Technologies (RATs). The wireless communication device may be configured to connect to one or more base stations via one or more RATs. A Concurrent RAT (CRAT) wireless communication device refers to a multi-SIM wireless communication device having two or more RATs concurrently enabled. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), High-Speed Downlink Packet Access (HSDPA), and the like), Global System for Mobile Communications (GSM), Code Division Multiple Access 1× Radio Transmission Technology (lx), General Packet Radio Service (GPRS), Wi-Fi, Personal Communications Service (PCS), and other protocols that may be used in a wireless communications network or a data communications network. Each RAT may be associated with a subscription or SIM.

A wireless communication device provided with a plurality of SIMs and connected to two or more networks with one SIM being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one is deactivated when the other one is in use. In another example, the MSMS communication device may be a Triple-SIM-Triple-Standby (TSTS) communication device, which includes three SIMs that may all be active on standby, where two may be deactivated when a third one is in use. In other examples, the MSMS communication device may be other suitable multi-SIM communication devices, with, for example, four or more SIMs, such that when one is in use, the others may be deactivated.

On the other hand, a wireless communication device that includes a plurality of SIMs and connects to two or more networks with two or more SIMs being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, examples described herein may be applicable to a wireless communication device that exchanges, with an associated network, device information such as, but not limited to, a change from a multi-SIM mode to a single-SIM mode (vice versa), change from a CRAT mode to a single SIM mode (vice versa), change in band preference associated with the first subscription, upgrading or downgrading carrier aggregation, and/or the like. Thus, the examples presented herein can be implemented on a multi-SIM device, MSMS device, MSMA device, CRAT device, or the like.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless communication device on a network and enable communication services with the network. A SIM as referred to herein may be a physical SIM, virtual SIM, soft SIM, or the like. Because the information stored in a SIM may be used to establish a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters) stored in a particular SIM as the SIM and the communication network, as well as the services and RATs supported by that network, correlate to one another.

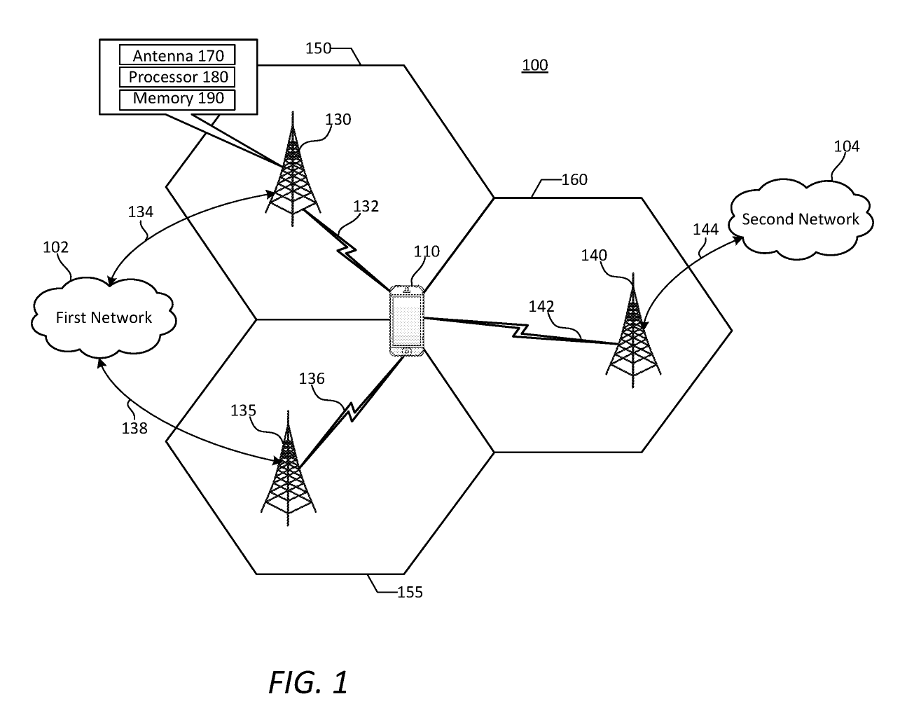

Various examples may be implemented within a communication system 100, an example of which is illustrated in FIG. 1. Referring to FIG. 1, a first network 102 may be provided by a first base station 130 and a third base station 135. A second network 104 may be provided by a second base station 140. The first base station 130 may enable the first network 102 in a first cell 150. The second base station 140 may enable the second network 104 in a second cell 160. The third base station 135 may enable the first network 102 in a third cell 155. A wireless communication device 110 may be associated with (within effective boundaries of) the first cell 150, the second cell 160, and the third cell 155.

The wireless communication device 110 may be in communication with the first network 102 through a first cellular connection 132 to the first base station 130 in some examples. In other examples, the wireless communication device 110 may be in communication with the first network 102 through the first cellular connection 132 and a third cellular connection 136 to the third base station 135, in a carrier aggregation scenario. The first cellular connection 132 may correspond to the first RAT of the wireless communication device 110. The third connection 136 may be made through the first RAT or another suitable RAT.

Carrier aggregation refers to aggregating channels enabled by two or more carriers to increase a total bandwidth, thus improving total throughput. Carrier aggregation can be implemented with both Frequency Division Duplexing (FDD) and Time Division Duplexing (TDD). Each carrier aggregated may be referred to as a component carrier. For instance, the first base station 130 (e.g., the first cell 150) may be a Primary Component Carrier (PCC). The third base station 135 (e.g., the third cell 155) may be a Secondary Component Carrier (SCC). While in the non-limiting example of FIG. 1, two component carriers are shown, one of ordinary skill in the art can appreciate that additional component carriers can be available to further improve communication throughput.

The wireless communication device 110 may be in communication with the second network 104 through a second cellular connection 142 to the second base station 140. The second cellular connection 142 may correspond to the second RAT of the wireless communication device 110, as in a multi-SIM context. The first base station 130 may be in communication with the first network 102 over a wired or wireless connection 134. The second base station 140 may be in communication with the second network 104 over a wired or wireless connection 144. The third base station 135 may be in communication with the first network 102 over a wired or wireless connection 138.

Each of the first cellular connection 132, the second cellular connection 142, or third cellular connection 136 may be a two-way wireless communication link. Each wireless communication link may be enabled by any suitable protocol (RAT) including, but not limited to, FDMA, TDMA, CDMA (e.g., EVDO), UMTS (e.g., WCDMA, LTE, HSDPA, or the like), GSM, 1×, GPRS, Wi-Fi, PCS, and/or another protocol used in a wireless communications network or a data communications network. By way of illustrating with a non-limiting example, the first cellular connection 132 and the third cellular connection 136 may be LTE connections. The second cellular connection 142 may be a LTE, WCDMA, GSM or 1× connection. Other RATs (such as, but not limited to, HSDPA, EVDO, and the like) may be implemented in a similar manner.

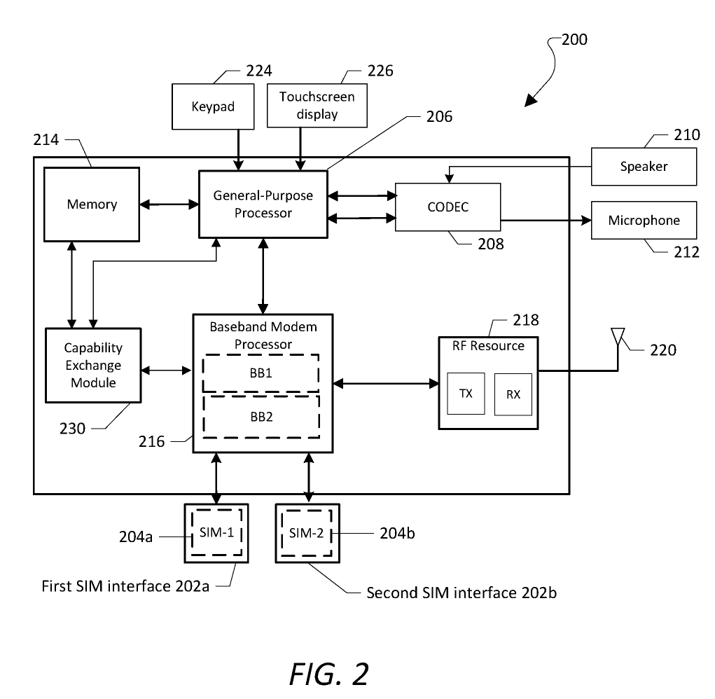

Each of the first base station 130, second base station 140, and third base station 135 may include at least one antenna group or transmission station located in a same or different areas. The at least one antenna group or transmission station (e.g., an antenna 170 of the first base station 130) may facilitate signal transmission and reception. Each of the first base station 130, second base station 140, and third base station 135 may include one or more processors (e.g., a processor 180 of the first base station 130), modulators, multiplexers, demodulators, demultiplexers, antennas, memories (e.g., a memory 190 of the first base station 130), and the like for performing the functions described herein. In some examples, the processor 180 and memory 190 may be similar to a processor 206 and memory 214 of FIG. 2, respectively. In some examples, the first base station 130, second base station 140, and third base station 135 may each be an access point, Node B, evolved Node B (eNodeB or eNB), base transceiver station (BTS), or the like.

In various examples, the wireless communication device 110 may be configured to access the first network 102 and the second network 104 by virtue of the multi-SIM and/or the multi-mode SIM configuration of the wireless communication device 110 (e.g., via one or more of the first cellular connection 132, the second cellular connection 142, or third cellular connection 136). When a SIM corresponding to a RAT is inserted or otherwise provided, the wireless communication device 110 may access the mobile communication network associated with that RAT based on the information stored on the SIM through registrations and call setups.

While the wireless communication device 110 is shown connected to the mobile networks 102 and 104 via two cellular connections, in other examples (not shown), the wireless communication device 110 may establish additional network connections using at least one additional RAT.

In some examples, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some examples, the wireless communication device 110 may establish a wireless connection with a wireless access point (not shown), such as over a Wi-Fi connection. The wireless access point may be configured to connect to the Internet or another network over a wired connection.

FIG. 2 is a functional block diagram of a wireless communication device 200 suitable for implementing various examples. According to various examples, the wireless communication device 200 may be the wireless communication device 110 as described with reference to FIG. 1. Referring to FIGS. 1-2, the wireless communication device 200 may include a first SIM interface 202a, which may receive a first identity module SIM-1 204a that is associated with the first subscription (corresponding to the first network 102). The wireless communication device 200 may include a second SIM interface 202b, which may receive a second identity module SIM-2 204b that is associated with the second subscription (corresponding to the second network 104).

A SIM (e.g., SIM-1 204a, SIM-2 204b, and/or the like) in various examples may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have one or more of a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. In an example in which the SIM is a virtual SIM or soft SIM, a SIM may be implemented within a portion of memory of the wireless communication device 200, and thus need not be a separate or removable circuit, chip, or card.

A SIM used in various examples may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may include a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RF resource chain. A baseband-RF resource chain may include the baseband modem processor 216, which may perform baseband/modem functions for communications on the SIMs. The baseband modem processor 216 may include one or more amplifiers and radios, referred to generally herein as a RF resource 218 or RF chain.

The examples described herein may be applicable to wireless communication devices in which the SIMs 204a and 204b share a common set of RF resource (particularly, the RF resource 218). Examples described herein may be applicable to wireless communication devices in which communication for each of the SIMs 204a and 204b are facilitated by a separate RF resource (such as, but not limited to, the RF resource 218).

The RF resource 218 may include at least one transceiver that perform transmit/receive functions for the associated SIMs 204a and 204b. The RF resource 218 may include separate transmit and receive circuitry, or may include a transceiver that combines transmitter and receiver functions. The RF resource 218 may be coupled to a wireless antenna 220. The RF resource 218 may be coupled to the baseband modem processor 216.

In some examples, the general-purpose processor 206, the memory 214, the baseband modem processor 216, and the RF resource 218 may be included in the wireless communication device 200 as a system-on-chip. In some examples, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communications therebetween.

The wireless communication device 200 may include a capability exchange module 230 capable of performing the functions described herein with respect to exchanging device capabilities (e.g., updating a change in device mode) with an associated network (e.g., the first network 102). Particularly, the capability exchange module 230 may facilitate implementation of a Radio Resource Control (RRC) layer that can detect a change in the device mode.

In some examples, the capability exchange module 230 may be implemented within the general-purpose processor 206. For example, the capability exchange module 230 may be implemented as a software application stored within the memory 214 and executed by the general-purpose processor 206. Accordingly, such examples can be implemented with minimal or no additional hardware costs. However, other examples relate to systems and processes implemented with dedicated hardware specifically configured for performing operations described herein with respect to the capability exchange module 230. For example, the capability exchange module 230 may be implemented as a separate processing component (i.e., separate from the general-purpose processor 206). The capability exchange module 230 may be coupled to the memory 214, the general processor 206, the baseband processor 216, and/or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further examples, such hardware and/or software may be added to the wireless communication device 200 post-manufacture, such as by installing one or more hardware devices and/or software applications onto the wireless communication device 200.

In some examples, the wireless communication device 200 may include, among other things, to additional SIMs, SIM interfaces, at least another RF resource associated with the additional SIMs, and additional antennas for connecting to additional mobile networks.

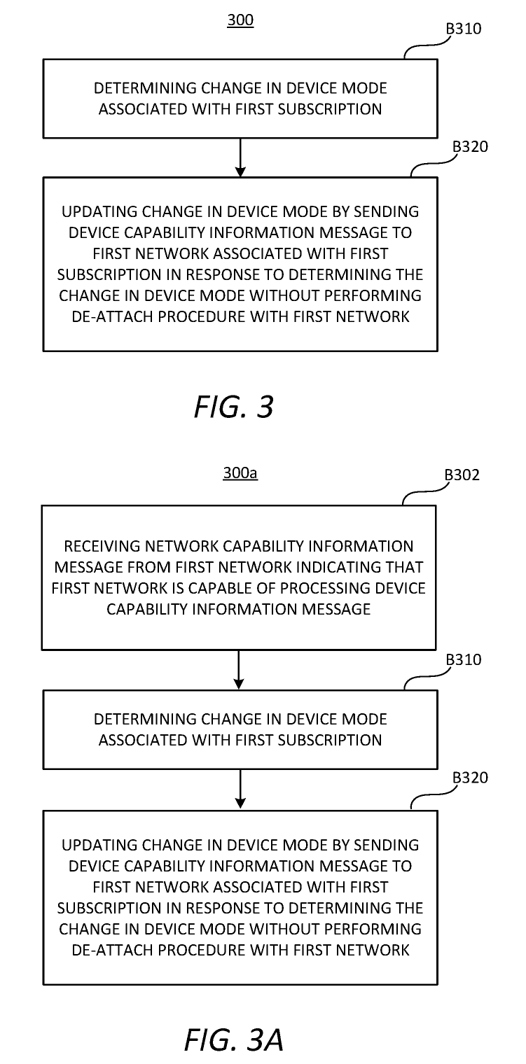

FIG. 3 is a process flowchart diagram illustrating a capability exchange method 300 according to various examples. Referring to FIGS. 1-3, in some examples, the capability exchange module 230 or the general-purpose processor 206 may be capable of configuring various aspects of the wireless communication device 200 to perform the capability exchange method 300. Generally, the capability exchange method 300 may include sending device mode information updates to the first network 102 without performing one or more of a de-attach or re-attach procedures with the first network 102, thus reducing signaling overhead, power consumption, and improving user-experience. The capability exchange method 300 may be implemented with the Extended LTE Signaling (ELS) framework and/or 3^{rd} Generation Partnership Project (3GPP) protocols.

At block B310, the capability exchange module 230 or the general-purpose processor 206 in the wireless communication device 200 may determine a change in device mode associated with a first subscription. The first subscription may be enabled by a first SIM (e.g., SIM-1 204a) and may be associated with the first network 102. The change in device mode may be determined while the wireless communication device 200 (e.g., the first subscription) is attached to the first network 102. The change in device mode may include one or more of: (1) changing from a multi-SIM mode to a single-SIM mode, vice versa; (2) a change from a CRAT mode to a single SIM mode vice versa; (3) a change in band preference associated with the first subscription; (4) upgrading carrier aggregation; (5) downgrading carrier aggregation, or the like.

In some examples, changing from a multi-SIM mode or CRAT mode to a single SIM mode of operation (or vice versa) can be triggered in response to the capability exchange module 230 or the general-purpose processor 206 determining that power consumption for supporting the multi-SIM/CRAT mode crosses a threshold. Other suitable factors such as network conditions can also trigger switching from the multi-SIM mode or CRAT mode to the single SIM mode, vice versa.

In some examples, upgrading carrier aggregation refers to adding at least one additional component carrier. Illustrating with a non-limiting example in which carrier aggregation has yet to be enabled (e.g., the first network 102 is provided by the first base station 130 (the first cell 150)), upgrading carrier aggregation refers to adding at least one carrier component (e.g., the third base station 135 (the third cell 155)) for improved throughput. Illustrating with another non-limiting example in which the first base station 130 (e.g., the PCC) and the third base station 135 (e.g., the SCC) are currently aggregated to facilitate access to the first network 102, upgrading carrier aggregation refers to adding an additional carrier component (not shown).

In some examples, downgrading carrier aggregation refers to removing at least one currently-aggregated component carrier. Illustrating with a non-limiting example in which the first base station 130 and the third base station 135 are currently aggregated, downgrading carrier aggregation refers to removing the SCC (e.g., the third base station 135) for power conservation. Illustrating with another non-limiting example in which the first base station 130 (e.g., the PCC), the third base station 135 (e.g., the SCC), and at least another component carrier (e.g., additional SCC) (not shown) are currently aggregated to facilitate access to the first network 102, downgrading carrier aggregation refers to removing at least one SCC.

At block B320, the capability exchange module 230 or the general-purpose processor 206 may update the change in device mode by sending a device capability information message to the first network 102 associated with the first subscription in response to determining the change in device mode without performing a de-attach procedure with the first network 102. That is, a de-attach procedure and/or a re-attach procedure may not need to be performed with the first network 102 given that the device capability information message can inform the first network 102 of the change in device mode. Thus, a seamless mobility is achieved.

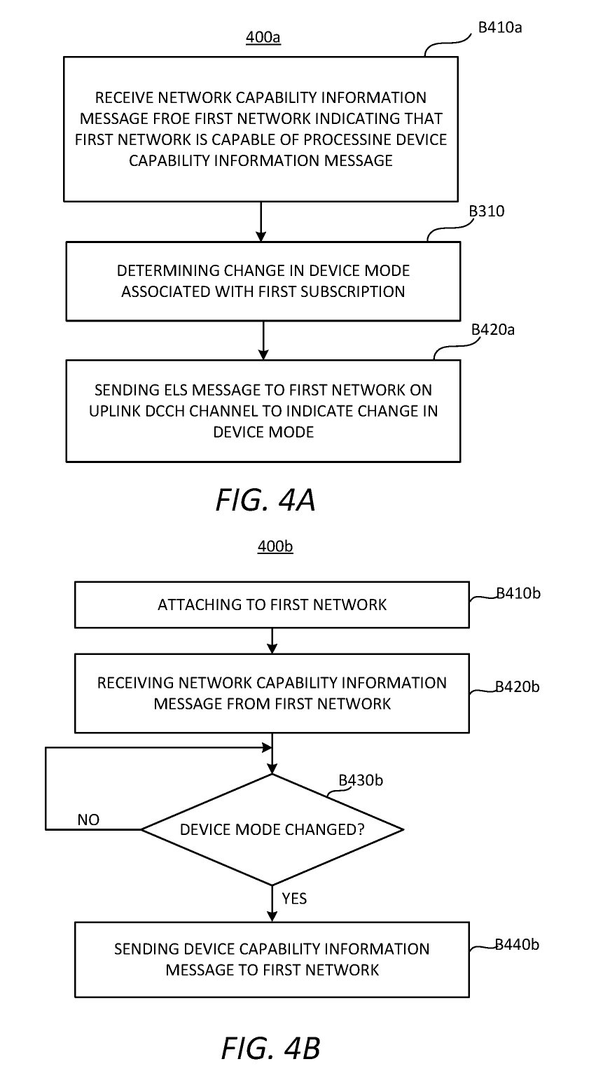

FIG. 4A is a process flowchart diagram illustrating a capability exchange method 400a according to various examples. Referring to FIGS. 1-4A, in some examples, the capability exchange module 230 or the general-purpose processor 206 may be capable of configuring various aspects of the wireless communication device 200 to perform the capability exchange method 400a. The capability exchange method 400a may be an example of a particular implementation of the method 300 using the ELS framework. Specifically, block B420a may be an example of a particular implementation of block B320. At block B410a, the wireless communication device 200 may receive from the first network 102 connected to the first subscription a network capability information message (e.g., a SIB1 broadcast message using a new Information Element (IE)) indicating whether the first network 102 is capable of handling the device capability information message from the wireless communication device 200.

At block B310, the capability exchange module 230 or the general-purpose processor 206 may determine the change in device mode associated with the first subscription in the manner described. At block B420a, the capability exchange module 230 or the general-purpose processor 206 may send an ELS message to the first network 102 on an uplink Dedicated Control Channel (DCCH) channel to indicate the change in device mode. The device capability information message in this case may be an autonomous Over-The-Air (OTA) message. The first network 102 may be capable of handling such message.

FIG. 4B is a process flowchart diagram illustrating a capability exchange method 400b according to various examples. Referring to FIGS. 1-4B, in some examples, the capability exchange module 230 or the general-purpose processor 206 may be capable of configuring various aspects of the wireless communication device 200 to perform the capability exchange method 400b. The capability exchange method 400b may be an example of a particular implementation of the method 300 using the 3GPP protocols. Specifically, one or more blocks of B410b-B440b may correspond to one of blocks B310 and B320.

At block B410b, the capability exchange module 230 or the general-purpose processor 206 may configure the RF resource 218 to attach to the first network 102. That is, the wireless communication device 200 may perform cell search and camping procedures for the first subscription with respect to the first network 102. In some examples, the wireless communication device 200 may access the first network 102 via the first base station 130 (without carrier aggregation), or via carrier aggregation relative to the PCC (e.g., the first base station 130) and at least one SCC (e.g., the third base station 135).

At block B420b, the capability exchange module 230 or the general-purpose processor 206 may configure the RF resource 218 to receive a network capability information message from the first network 102. The network capability information message may indicate that the first network 102 is capable of processing the device capability information message transmitted by connected devices, including the wireless communication device 200. The network capability information message may be included as a part of a System Information Block (SIB) (e.g., SIB 1) broadcasted by the first network 102 via one or more of the first base station 130, third base station 135, or another base station not shown.

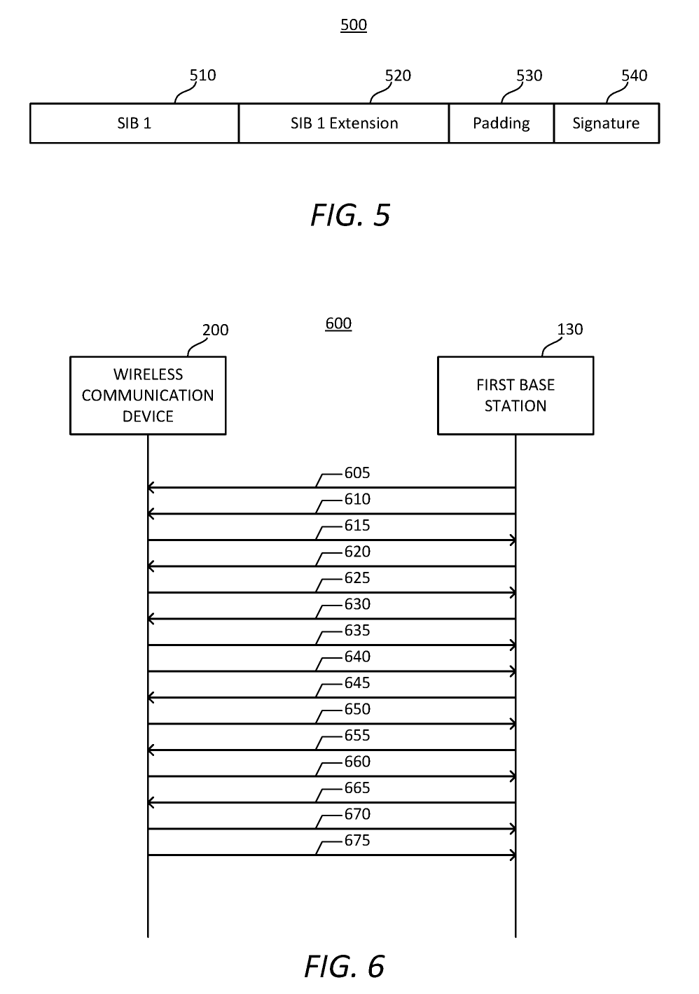

FIG. 5 is a diagram illustrating an example of a SIB 500 used to transmit the network capability information message. Referring to FIGS. 1-5, the SIB 500 may be SIB 1. The SIB 500 may include a SIB 1 content portion 510, which uses the Abstract Syntax Notation One (ASN.1) standard. The SIB 500 may include a SIB 1 extension portion 520, which may include a Network Feature Group Indicator (NWFGI) corresponding to the network capability information message. The SIB 1 extension portion 520 may use the ASN.1 standard. The SIB 500 may include padding 530 and/or signature 540. The signature 540 may be an ELS signature. One or more of the SIB 1 extension portion 520, padding 530, or signature 540 may be extensions to the SIB 1 content portion 510.

At block B430b, the capability exchange module 230 or the general-purpose processor 206 may determine whether the device mode has changed. In response to determining that the device mode has not changed (B430b:NO), the method 400b returns to block B430b. On the other hand, in response to determining that the device mode has changed (B430b:YES), the capability exchange module 230 or the general-purpose processor 206 may send the device capability information message to the first network 102 at block B440b.

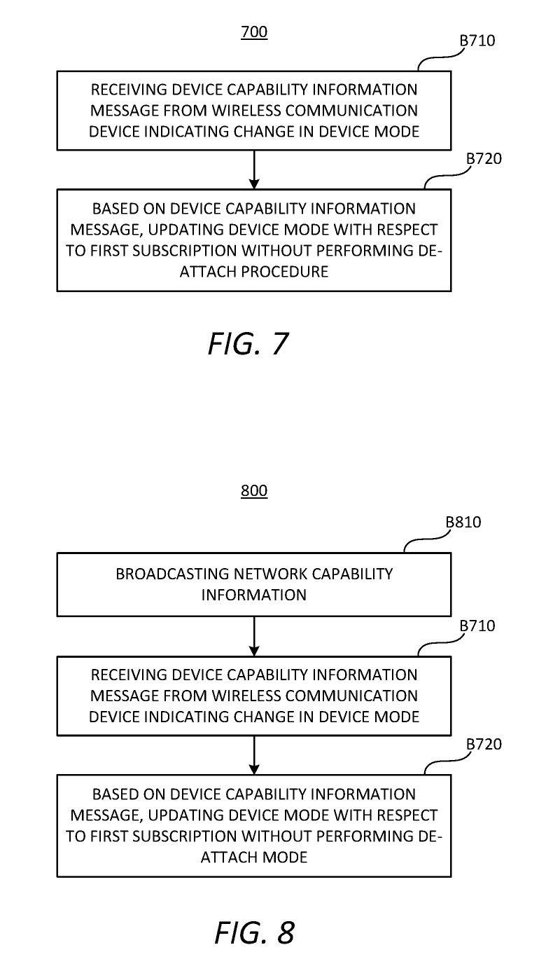

FIG. 6 is a signaling diagram illustrating a capability exchange method 600 according to various examples. Referring to FIGS. 1-6, the capability exchange method 600 may correspond to one or more of the methods 300, 400a, 400b, 700 (FIG. 7), or 800 (FIG. 8). In some examples, the capability exchange module 230 or the general-purpose processor 206 may be capable of configuring various aspects of the wireless communication device 200 to perform the signaling shown in FIG. 6. The processor 180 may be capable of configuring various aspects of the first base station 130 to perform the signaling shown in FIG. 6.

At signaling block 605, the first base station 130 may send one or more Primary Synchronization Signals (PSS), Secondary Synchronization Signals (SSS), Physical Broadcast Channel (PBCH) messages, SIBs, or the like to the wireless communication device 200 (100). At signaling block 610, the first base station 130 may send (e.g., broadcast) the SIB 500 (e.g., SIB 1), including at least the SIB 1 content portion 510, the SIB 1 extension portion 520, and the signature 540. In other words, the first network 102 may send the network capability information message at signaling block 610. At signaling block 615, the capability exchange module 230 or the general-purpose processor 206 may configure the RF resource 218 to send MSG1 of a Random Access Channel (RACH) procedure to the first base station 130. At signaling block 620, the first base station 130 may send MSG2 of the RACH procedure as a response to MSG1 to the wireless communication device 200.

At signaling block 625, the capability exchange module 230 or the general-purpose processor 206 may configure the RF resource 218 to send a RRC connection request to the first base station 130. At signaling block 630, the first base station 130 may send a RRC connection setup message to the wireless communication device 200. At signaling block 635, the capability exchange module 230 or the general-purpose processor 206 may configure the RF resource 218 to send a RRC connection setup complete message (e.g., an attach request) to the wireless communication device 200. At signaling block 640, the capability exchange module 230 or the general-purpose processor 206 may configure the RF resource 218 to send a device ELS indication to the first base station 130 to indicate that the wireless communication device 200 is ELS-compatible. The device ELS indication may be sent as a response to the network capability information message received by the wireless communication device 200 at signaling block 610.

At signaling block 645, the first base station 130 may send a security mode command to the wireless communication device 200. At signaling block 650, the capability exchange module 230 or the general-purpose processor 206 may configure the RF resource 218 to send a security mode complete message to the first base station 130. At signaling block 655, the first base station 130 may send a ELS capability enquiry to the wireless communication device 200. As a response, the capability exchange module 230 or the general-purpose processor 206 may configure the RF resource 218 to send a ELS capability information to the first base station 130 at signaling block 660. The ELS capability information sent at signaling block 660 may be initial device capability information (e.g., a set of parameters indicating an initial device mode).

At signaling block 665, the first base station 130 may send a ELS RRC connection reconfiguration message to the wireless communication device 200. The capability exchange module 230 or the general-purpose processor 206 may perform a ELS RRC connection reconfiguration based on the ELS RRC connection reconfiguration message and may configure the RF resource 218 to send a ELS RRC connection reconfiguration complete message to the first base station 130 at signaling block 670.

At signaling block 675, the capability exchange module 230 or the general-purpose processor 206 may configure the RF resource 218 to send the device capability information message to the first base station 102130 That is, in response to detecting a change in device mode from what is reported to the first base station 130 at signaling block 660, the device capability information message may be sent to the first base station 130. Sending the device capability information message at signaling block 675 may be contingent upon receiving and decoding the network capability information message at signaling block 610.

FIG. 7 is a process flowchart diagram illustrating a capability exchange method 700 according to various examples. Referring to FIGS. 1-7, in some examples, the processor 180 may be capable of configuring various aspects of the first base station 130 to perform the capability exchange method 700. Generally, the capability exchange method 700 may include receiving device mode information updates from the wireless communication device 200 without performing one or more of a de-attach or re-attach procedures with the wireless communication device 200, thus reducing signaling overhead, power consumption, and improving user-experience. The capability exchange method 700 may be implemented with the ELS framework and/or the 3^{rd} Generation Partnership Project (3GPP) protocols.

At block B710, the processor 180 may configure the antenna 170 of the first base station 130 to receive the device capability information message form the wireless communication device 200, indicating a change in the device mode. Based on the device capability information message, the processor 180 may update the device mode with respect to the first subscription without performing a de-attach procedure with the wireless communication device 200. That is, a de-attach procedure and/or a re-attach procedure may not need to be performed with the wireless communication device 200 given that the device capability information message can inform the first network 102 of the change in device mode. Various parameters relative to the device mode of the wireless communication device 200 may be stored in the memory 190. As the device mode with respect to the wireless communication device 200 is updated, the manner in which future communications with the wireless communication device 200 takes place may be altered based on the updated device mode.

FIG. 8 is a process flowchart diagram illustrating a capability exchange method 800 according to various examples. Referring to FIGS. 1-8, in some examples, the processor 180 may be capable of configuring various aspects of the first base station 130 to perform the capability exchange method 800. The capability exchange method 800 may include the capability exchange method 700 and a staging mechanism. For instance, at block B810, the processor 180 may configure the antenna 170 of the first base station 130 to broadcast network capability information to all devices (including the wireless communication device 200) with the first cell 150. For instance, the SIB 500 may be used as a vehicle for informing the devices camped on the first cell 150 the network's capability to handle the device capability information message.

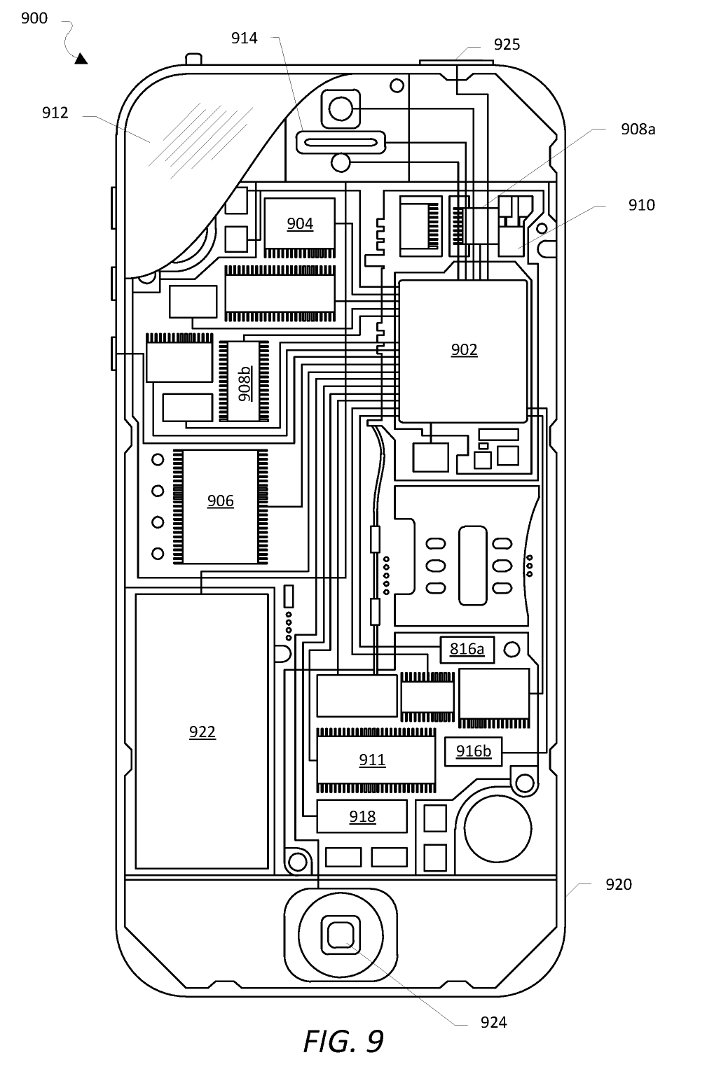

The various examples may be implemented in any of a variety of wireless communication devices 110 and 200, an example of which is illustrated in FIG. 9, as a wireless communication device 900. As such, the wireless communication device 900 may implement the process and/or the apparatus of FIGS. 1-8, as described herein.

With reference to FIGS. 1-9, the wireless communication device 900 may include a processor 902 coupled to a touchscreen controller 904 and an internal memory 906. The processor 902 may be one or more multi-core integrated circuits designated for general or specific processing tasks. The memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the wireless communication device 900 need not have touch screen capability.

The wireless communication device 900 may have one or more cellular network transceivers 908a, 908b coupled to the processor 902 and to at least one antenna 910 and configured for sending and receiving cellular communications. The transceivers 708a, 908b and antenna 910 may be used with the above-mentioned circuitry to implement the various example methods. The cellular network transceivers 908a, 908b may be the RF resource 218. The antenna 910 may be the antenna 220. The wireless communication device 900 may include two or more SIM cards 916a, 916b, corresponding to SIM-1 204a and SIM-2 204b (respectively), coupled to the transceivers 908a, 908b and/or the processor 902. The wireless communication device 900 may include a cellular network wireless modem chip 911 (e.g., the baseband modem processor 216) that enables communication via at least one cellular network and is coupled to the processor 902.

The wireless communication device 900 may include a peripheral device connection interface 918 coupled to the processor 902. The peripheral device connection interface 918 may be singularly configured to accept one type of connection, or multiply configured to accept various types of physical and communication connections, common or proprietary, such as USB, FireWire, Thunderbolt, or PCIe. The peripheral device connection interface 918 may also be coupled to a similarly configured peripheral device connection port (not shown).

The wireless communication device 900 may also include speakers 914 for providing audio outputs. The wireless communication device 900 may also include a housing 920, constructed of a plastic, metal, or a combination of materials, for containing all or some of the components discussed herein. The wireless communication device 900 may include a power source 922 coupled to the processor 902, such as a disposable or rechargeable battery. The rechargeable battery may also be coupled to a peripheral device connection port (not shown) to receive a charging current from a source external to the wireless communication device 900. The wireless communication device 900 may also include a physical button 924 for receiving user inputs. The wireless communication device 900 may also include a power button 926 for turning the wireless communication device 900 on and off.

The various examples illustrated and described are provided merely as examples to illustrate various features of the claims. However, features shown and described with respect to any given example are not necessarily limited to the associated example and may be used or combined with other examples that are shown and described. FIG. 3A is a process flowchart diagram illustrating a capability exchange method 300a according to various examples. In addition to blocks B310 and B320 of the method 300, the method 300a further includes block B302. At block B302, the wireless communication device 200 may receive from the first network 102 connected to the first subscription a network capability information message (e.g., a SIB1 broadcast message using a new Information Element (IE)) indicating that the first network 102 is capable of processing the device capability information message from the wireless communication device 200. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the examples disclosed herein may be implemented or performed with a general purpose processor, a DSP, an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present invention. Various modifications to these examples will be readily apparent to those skilled in the art, and the generic principles defined herein may be applied to some examples without departing from the spirit or scope of the invention. Thus, the present invention is not intended to be limited to the examples shown herein but is to be accorded the widest scope consistent with the following claims and the principles and novel features disclosed herein.

What is claimed is:

1. A method for a wireless communication device having a first Subscriber Identity Module (SIM) enabling a first subscription and a second SIM enabling a second subscription to manage communications over the first subscription and the second subscription, the method comprising:
determining a change in device mode associated with the first subscription; and
updating the change in device mode by sending a device capability information message to the first network associated with the first subscription in response to determining the change in device mode without performing a de-attach procedure with the first network.

2. The method of claim 1, wherein the change in device mode comprises:
a change from a multi-SIM mode to a single-SIM mode; or
a change from a Concurrent-SIM (CRAT) mode to a single SIM mode.

3. The method of claim 1, wherein the change in device mode comprises a change in band preference associated with the first subscription.

4. The method of claim 1, wherein the change in device mode comprises upgrading or downgrading carrier aggregation.

5. The method of claim 4, wherein upgrading the carrier aggregation comprises adding an additional component carrier.

6. The method of claim 4, wherein downgrading the carrier aggregation comprises removing a current component carrier.

7. The method of claim 1, wherein the change in device mode is updated without performing a re-attach procedure with the first network.

8. The method of claim 1, wherein the change in device mode is determined while the first subscription is attached to the first network.

9. The method of claim 1, wherein the device capability information message is an Extended Long Term Evolution (LTE) Signaling (ELS) message.

10. The method of claim 1, wherein the device capability information message is sent via an uplink Dedicated Control Channel (DCCH) channel.

11. The method of claim 1, wherein the device capability information message is an Over-The-Air (OTA) message.

12. The method of claim 1, further comprising receiving a network capability information message from the first network indicating that the first network is capable of processing the device capability information message.

13. The method of claim 12, wherein the network capability information message is received via a System Information Block (SIB).

14. A wireless communication device, comprising:
at least one radio frequency (RF) resource;
a processor configured to connect to a first Subscriber Identity Module (SIM) associated with a first subscription and to a second SIM associated with a second subscription, and configured with processor-executable instructions to:
determine a change in device mode associated with the first subscription; and
update the change in device mode by sending a device capability information message to the first network associated with the first subscription in response to determining the change in device mode without performing a de-attach procedure with the first network; and
a memory.

15. A method for a processor of a first network to manage communications with a wireless communication device having at least a first Subscriber Identity Module (SIM) that enables a first subscription associated with the first network, the method comprising:
receiving a device capability information message from the wireless communication device indicating a change in device mode; and
based on the device capability information message, updating the device mode with respect to the first subscription of the wireless communication device without performing a de-attach procedure with the wireless communication device.

16. The method of claim 15, wherein the change in device mode comprises:
a change from a multi-SIM mode to a single-SIM mode; or
a change from a Concurrent-SIM (CRAT) mode to a single SIM mode.

17. The method of claim 15, wherein the change in device mode comprises a change in band preference associated with the first subscription.

18. The method of claim 15, wherein the change in device mode comprises upgrading or downgrading carrier aggregation.

19. The method of claim 18, wherein upgrading the carrier aggregation comprises adding an additional component carrier.

20. The method of claim 18, wherein downgrading the carrier aggregation comprises removing a current component carrier.

21. The method of claim 15, wherein the change in device mode is updated without performing a re-attach procedure with the wireless communication device.

22. The method of claim 15, wherein the device capability information message is received while the first subscription is attached to the first network.

23. The method of claim 15, wherein the device capability information message is an Extended Long Term Evolution (LTE) Signaling (ELS) message.

24. The method of claim 15, wherein the device capability information message is received via an uplink Dedicated Control Channel (DCCH) channel.

25. The method of claim 15, wherein the device capability information message is an Over-The-Air (OTA) message.

26. The method of claim 15, further comprising sending a network capability information message to the wireless communication device indicating that the first network is capable of receiving and processing the device capability information message.

27. The method of claim 26, wherein the network capability information message is sent via a System Information Block (SIB).

28. A base station associated with a first network having a processor capable of managing communications with a wireless communication device having at least a first Subscriber Identity Module (SIM) that enables a first subscription associated with the first network, the processor is capable of:
configuring the base station to receive a device capability information message from the wireless communication device indicating a change in device mode; and
based on the device capability information message, updating the device mode with respect to the first subscription of the wireless communication device without performing a de-attach procedure with the wireless communication device.
